(19) United States
(12) Patent Application Publication
(10) Pub. No.: US 2020/0165966 A1
(43) Pub. Date: May 28, 2020

(54) ASSEMBLY COMPRISING AN ACTUATOR

(71) Applicant: Mahle International GmbH, Stuttgart (DE)

(72) Inventor: Peer Niekamp, Leutenbach (DE)

(21) Appl. No.: 16/631,746

(22) PCT Filed: Jul. 17, 2018
(86) PCT No.: PCT/EP2018/069373

§ 371 Date: Jan. 16, 2020

(30) Foreign Application Priority Data
Jul. 17, 2017 (DE) 10 2017 212 213.7

(51) Int. Cl. F02B 37/18; F04D 27/00; F04D 29/42

(52) U.S. Cl. CPC F02B 37/18; F04D 29/4206; F04D 27/009

(57) ABSTRACT

An assembly may include an actuator. The actuator may include an actuator housing delimiting an actuator housing interior space and a ventilation line disposed within the actuator housing. The ventilation line may be guided from the actuator housing interior space to an outside and opening out in a ventilation opening arranged on an outer side of a housing wall of the actuator housing. The assembly may also include a housing including a housing flange. The ventilation line may be closed via an air-permeable and liquid-impermeable membrane. The actuator may further include a positioning dome arranged on the ventilation opening and projecting outward from the actuator housing. The positioning dome disposed integrally on the actuator housing. When the actuator is mounted on the housing, the positioning dome may engage a recess disposed on the housing flange facilitating positioning the actuator housing relative to the housing flange.

### CROSS-REFERENCE TO RELATED APPLICATIONS

This application claims priority to International Patent Application No. PCT/EP2018/069373, filed on Jul. 17, 2018, and German Patent Application No. DE 10 2017 212 213.7, filed on Jul. 17, 2017, the contents of both of which are hereby incorporated by reference in their entirety.

### TECHNICAL FIELD

The present invention relates to an assembly comprising an actuator as well as an exhaust gas turbocharger comprising such an actuator, and an air management system comprising such an actuator.

### BACKGROUND

In exhaust gas turbochargers and air management systems for internal combustion engines, adjustable components, such as, for example, an adjustable wastegate valve or an adjustable variable turbine geometry or ventilation flaps, respectively, are activated with the help of an active component, the so-called actuator—also known to the person of skill in the art under the name “control device”.

Oftentimes, the actuator is an electric motor. A power electronics for activating and controlling the electric motor are thus also often accommodated in the housing. The electric motor serves to mechanically activate a control element, which, in turn, can be mechanically coupled to the component, which is to be activated.

Depending on the place of installation of the actuator, an ambient temperature of the surrounding area of the control device can vary. Due to the fact that the actuator housing interior space enclosed by the actuator housing is usually constant, the pressure in the actuator housing interior thus varies. To avoid damages to or in the actuator housing, it is expedient to ensure a pressure compensation between the surrounding area and the actuator housing interior space. For this purpose, it is possible to provide a ventilation line on the actuator housing, which leads through the actuator housing and which fluidically connects the actuator housing interior space to the external surrounding area of the actuator housing in this way. To avoid an ingress of dirt or ingress of moisture through the ventilation opening into the housing interior space, the ventilation opening can be covered with a membrane, which is permeable for gas, while it is impermeable for liquid.

It has been shown that in particular in the case of vehicle applications, it is possible that the vehicle is also cleaned in the area of the actuator with a high-pressure cleaner, in the case of which a high-pressure jet of liquid or gaseous cleaning agent is applied to the surfaces to be cleaned. This creates the risk that the ventilation line or the membrane, respectively, is subjected directly to this high-pressure jet, which can lead to damages to the membrane or to penetration of the used cleaning agent into the actuator housing internal space, respectively.

Independently of this set of problems, the actuator comprising the actuator housing is mounted as structural unit on the housing of an exhaust gas turbocharger—for example on a bearing housing, on a compressor housing or on a turbine housing—or also to the housing of an intake module, of a fresh air system or other air management systems. To ensure that the actuator also works properly after mounting on the turbocharger or on the air management system, respectively, has taken place, a precise positioning of the actuator housing comprising the actuator on the respective housing is required. It is known from conventional exhaust gas turbochargers or conventional air management systems, respectively, to provide positioning elements on the actuator housing, which can be formed, for example, as projections projecting from the actuator housing comprising a dome-like geometric shape. Recesses, which are formed complementary to these projections and with which the projections engage after mounting has taken place, are accordingly provided on the housing of the turbocharger or of the air management system, respectively. The projections and the recesses are thereby arranged on the actuator housing or on the housing of the exhaust gas turbocharger, respectively, or air management system, respectively, in such a way that the actuator housing and the housing of the exhaust gas turbocharger or air management system, respectively, are positioned relative to one another as desired after mounting has taken place.

### SUMMARY

The present invention now deals with the problem of creating an improved embodiment for an assembly comprising an actuator and comprising a housing for an exhaust gas turbocharger or for an air management system, which is in particular characterized in that the risk of a penetration of unwanted contaminations into a ventilation line, which is present in the actuator, is prevented. A solution is to simultaneously be found, in the case of which a precise mounting of the actuator on the housing of the exhaust gas turbocharger or of the air management system, respectively, is possible.

This problem is solved according to the invention by means of the subject matter of the independent claim(s). Advantageous embodiments are subject matter of the dependent claim(s).

It is thus the general idea of the invention to simultaneously form a cover of a ventilation opening, which is provided on the actuator housing, as positioning dome, which facilitates the positioning of the actuator housing in response to the mounting on another housing, in particular on a housing of an exhaust gas turbocharger or of an air management system. The provision of a separate positioning device for positioning the actuator housing relative to the housing can thus be forgone in the case of the solution according to the invention as proposed here. This results in cost advantages in the production.

An assembly according to the invention comprises an actuator for attaching to a housing, preferably of an exhaust gas turbocharger or of an air management system. The actuator comprises an actuator housing, which delimits an actuator housing interior space. In the actuator housing, there is formed a ventilation line, which is guided from the actuator housing interior space to the outside and opens out in a ventilation opening, which is arranged on an outer side of a housing wall of the actuator housing. The ventilation line is closed by an air-permeable and liquid-impermeable membrane. The assembly according to the invention further comprises a housing, preferably of an exhaust gas turbocharger or of an air management system, which has a housing flange. The actuator has a positioning dome, which is arranged on the ventilation opening and which projects outward from the actuator housing and which is formed integrally on the actuator housing. When the actuator is mounted on the housing, the positioning dome engages with a recess provided on the housing flange in order to position the actuator housing relative to the housing flange of the housing in this way. The positioning dome facilitates an positioning of the actuator housing relative to the housing on the one hand, and simultaneously protects the ventilation line, which opens out into the ventilation opening, against contamination.

According to a preferred embodiment, the positioning dome partially closes the ventilation opening and/or partially covers it. The positioning dome is preferably arranged on the ventilation opening in such a way that the ventilation opening is formed by at least two venting slots. By means of such a formation of the ventilation opening in the form of venting slots, the membrane arranged in the ventilation line can be protected particularly effectively against damages or contamination, without thereby negatively impacting the ventilating effect of the ventilation line.

In the case of an advantageous further development, the positioning dome has a main body. The main body merges radially outward into at least two fastening elements, by means of which the positioning dome is connected to the housing wall. A positioning dome formed in this way is mechanically particularly stable, so that signs of wear can be largely or even completely avoided even in the case of a plurality of mounting cycles.

The at least one positioning dome is advantageously formed integrally on the housing wall. This makes it possible to also produce the positioning dome as part of the production of the actuator housing, for example by means of an injection molding process. A separate manufacturing step for producing the positioning dome on the actuator housing is no longer necessary in the case of this embodiment. This measure leads to cost advantages in the production of the actuator.

In the top view, the main body preferably has the geometry of a circle, and the fastening elements each have the geometry of a segment of a circle projecting radially outward from the main body. Such a geometry facilitates the effective coverage of the ventilation opening in such a way that the membrane is effectively protected against contamination or damages from the outside on the one hand, but that the fluid connection to the external surrounding area of the actuator housing, which is required for the ventilation line, is nonetheless maintained.

According to another preferred embodiment, the at least two fastening elements are each formed as fastening webs. In the top view, said fastening elements extend radially outward, away from the main body, which is preferably formed cylindrically, in the case of this embodiment. Such a design of the fastening elements ensures a high mechanical strength of the positioning dome.

According to another preferred embodiment, a respective outer circumferential side of the at least two fastening elements abuts on an inner circumferential side of the housing flange, which delimits the recess, when the actuator is mounted on the exhaust gas turbocharger. This ensures that, after the actuator housing has been mounted on the respective housing, the lateral play between the two housings is small. A high positioning accuracy is thus ensured.

Four fastening elements preferably project from the main body, so that four venting slots are formed. Particularly preferably, the four fastening elements have a 90° rotational symmetry with respect to a center of the ventilation opening. A highly effective fluidic connection between the ventilation line and the external surrounding area of the actuator housing can be ensured in this way.

In the case of a further preferred embodiment, the positioning dome projects outward from the housing wall and is arranged concentrically to the ventilation opening or the venting slots, respectively.

In the case of another preferred embodiment, the positioning dome partially covers the ventilation opening in a viewing direction perpendicular to the housing wall in such a way that at least two venting slots are visible in this viewing direction. On the one hand, this embodiment provides for a particularly precise positioning of the actuator housing by means of the positioning dome. On the other hand, however, a fluidic connection, which is sufficient for the ventilation, of the ventilation line with the external surrounding area of the actuator housing is also ensured.

In the case of a further preferred embodiment, which effectively protects the membrane provided in the ventilation line against contamination or destruction, the main body is arranged completely inside an opening edge of the ventilation opening. In the case of this embodiment, the at least two fastening elements project radially beyond the opening edge of the ventilation opening and are connected to the housing wall. The fastening elements are thereby dimensioned in such a way that at least two venting slots are formed by means of the areas of the ventilation opening, which are not covered by the positioning dome in the top view.

In the case of an advantageous further development, an inner side of the main body facing the housing wall is arranged flush with an outer side of the housing wall.

According to another preferred embodiment, the inner side of the main body facing the housing wall is arranged at a distance from the outer side of the housing wall. In the case of this embodiment, the arrangement of the housing wall spaced apart from the main body takes place in such a way that a between the outer side of the housing wall and the inner side of the main body forms a space, which preferably forms the at least two venting slots. In the case of this embodiment, a penetration of dirt or moisture into the ventilation opening is prevented particularly effectively.

In the case of an advantageous further development, the main body closes the ventilation opening in an opaque manner along the viewing direction perpendicular to the housing wall. In the case of this further development, the penetration of dirt or moisture, respectively, into the ventilation line or into the actuator housing interior space, respectively, is also prevented particularly effectively.

The recess provided on the housing flange can advantageously be formed as a passage opening.

In the case of a further preferred embodiment, the passage opening is formed/dimensioned in such a way that when the actuator is mounted on the exhaust gas turbocharger or on the air management system, respectively, the at least two venting slots are either covered in an opaque manner or, alternatively, are visible, in the top view along the viewing direction perpendicular to the housing wall. In the case of this alternative, the venting slots are effectively protected against contamination and moisture when the actuator housing is mounted.

In the case of an advantageous further development, at least one projection is formed on the housing flange. Said projection, which can preferably be formed in a ring-like manner, projects radially inward into the passage opening in the case of this further development, so that the at least two venting slots are covered in an opaque manner in the viewing direction. In the case of this alternative, the venting slots are effectively protected against contamination and moisture when the actuator housing is mounted.

In the case of another advantageous further development, the passage opening or the housing flange delimiting the passage opening, respectively, has a radial step, which divides the passage opening into a first axial section, which faces the actuator housing and comprises a first opening diameter, and into a second axial section, which faces away from the actuator housing and comprises a second opening diameter. In the case of this further development, the second opening diameter is smaller than the first opening diameter. The second opening diameter is additionally selected in such a way that the at least two venting slots are covered in an opaque manner in the viewing direction.

In the case of a further advantageous further development, at least one further positioning dome is arranged on the actuator housing, preferably on the housing wall. Analogously to the above-presented positioning dome, said positioning dome can be formed in the manner of a projection projecting away from the housing wall. However, the further positioning dome does not serve to cover the ventilation opening of a ventilation line, such as the above-described positioning dome, which is essential for invention, but supports a simplified positioning of the actuator on the housing of the exhaust gas turbocharger or air management system, respectively. When the actuator is mounted on the housing of the exhaust gas turbocharger or of the air management system, respectively, the at least one further positioning dome engages with a recess, which is formed complementary to the further positioning dome and which is formed on the housing, preferably on the housing flange. Particularly preferably, this recess only partially surrounds the additional positioning dome. An positioning of the two housings relative to one another, which is improved once again, can be attained in this way.

In the case of a preferred embodiment, the ventilation opening on the actuator housing is arranged laterally offset to the positioning dome. This makes it possible to position the ventilation line in the actuator, independently of the position of the positioning dome. When the actuator is mounted on the housing, a complete coverage of the ventilation opening can furthermore be attained in this way by means of the housing flange of the housing. A particularly effective protection against splash water is attained in this way.

Particularly preferably, a depression is formed on the outer side of the actuator housing between the ventilation opening and the positioning dome. When the actuator is mounted on the housing, the depression advantageously forms a ventilation duct, which connects the ventilation opening to the recess provided on the housing flange.

Particularly preferably, the positioning dome delimits the ventilation duct in some sections. The additional provision of a delimitation of the ventilation duct is no longer necessary in this way.

According to an advantageous further development, the ventilation duct, starting at the ventilation opening, has a first duct section, which is delimited by the housing flange and the housing wall, and which, towards the positioning dome, merges into a second duct section, which is delimited by the housing flange and by the positioning dome. The ventilation duct can be realized particularly easily in this way, in particular without providing additional components. This results in cost advantages in the production.

The first duct section is advantageously arranged at an angle, preferably orthogonally, to the second duct section.

The invention further relates to an exhaust gas turbocharger comprising an above-presented assembly. The above-described advantages of the assembly thus also transfer to the exhaust gas turbocharger.

The invention further relates to an air management system, in particular an intake module or a fresh air system, comprising an above-presented assembly. The above-described advantages of the assembly thus also transfer to the air management system.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows the actuator of an assembly according to the invention in perspective illustration,

FIG. 2 shows the actuator housing of the actuator according to FIG. 1 when mounted on the housing of an exhaust gas turbocharger,

FIG. 3 shows a detail illustration of FIG. 1 in the area of the positioning dome formed on the actuator housing,

FIG. 4 shows a top view onto the actuator housing in the area of the positioning dome,

FIG. 5 shows a highly simplified sectional illustration, which illustrates the arrangement of actuator housing and housing relative to one another and in the case of which the ventilation opening formed on the actuator housing is covered in an opaque manner by the housing of the exhaust gas turbocharger or of the air management system, respectively,

FIG. 6 shows an alternative of the arrangement of FIG. 5,

FIG. 7 shows an alternative of the example of FIGS. 1 to 5 in a perspective illustration in the area of the positioning dome, analogously to FIG. 3,

FIG. 8 shows a simplified sectional illustration, which illustrates the arrangement of housing wall and main body of the positioning dome according to FIG. 7,

FIG. 9 shows a more detailed illustration of FIG. 8,

FIG. 10 shows an alternative of the example of FIG. 5.

### DETAILED DESCRIPTION

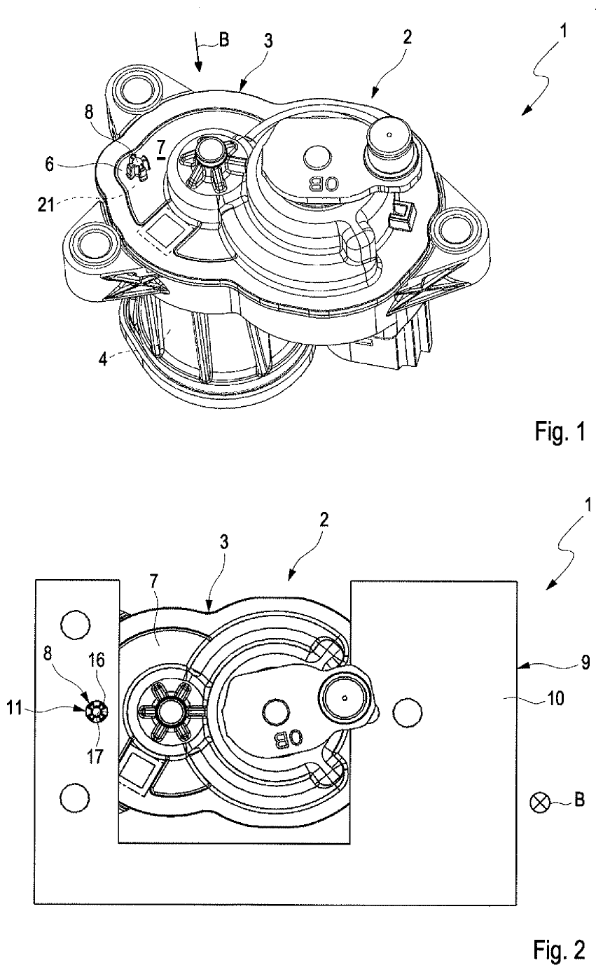

FIG. 1 shows an actuator 2 of an assembly 1 according to the invention in an exemplary manner. The actuator 2 serves to activate an adjustable component of an exhaust gas turbocharger, which is not illustrated in more detail in FIG. 1 and which, just as the actuator 2, is part of the assembly 1. A wastegate valve or a variable turbine geometry of the exhaust gas turbocharger can, for example, be activated by means of the actuator 2, which is attached to the exhaust gas turbocharger. The actuator 2, however, can also serve to activate an adjustable flap of an air management system (not show), in particular of an intake module or of a fresh air system of an internal combustion engine.

The actuator 2 comprises an actuator housing 3, which delimits an actuator housing interior space 4 (covered by the actuator housing 3 in FIG. 1). In the actuator housing 3, there is formed a ventilation line 21, which is guided from the actuator housing interior space 4 to the outside for pressure compensation. The ventilation line opens out in a ventilation opening 5 arranged on an outer side 6 of a housing wall 7 of the actuator housing 3. The actuator 2 comprises a positioning dome 8, which is arranged on the ventilation opening 5 and which projects outward away from the actuator housing 3. The positioning dome 8 serves to position or centering, respectively, the actuator housing 3 relative to the exhaust gas turbocharger, when the actuator 2 is to be fastened to a housing 9 of the exhaust gas turbocharger. At the same time, it partially closes the ventilation opening or partially covers it, respectively.

The illustration of FIG. 2 clarifies this. According to FIG. 2, the housing 9 comprises a housing flange 10, to which the actuator 2 comprising the actuator housing 3 can be fastened. For the sake of clarity, the housing flange 10 is only shown in simplified illustration in FIG. 2. As illustrated by the illustration of FIG. 2, which shows the housing wall 7 of the actuator housing 3 when mounted on the housing flange 10 of the housing 9, the positioning dome 8 engages with a recess 11 provided on the housing flange 10 when the actuator 2 is mounted on the housing 9 of the exhaust gas turbocharger.

In the case of the assembly 1 presented here, the positioning dome 8 does not only serve to position the actuator housing 3 relative to the housing 9, but simultaneously protects an air-permeable and liquid-impermeable membrane 27 (not visible in the illustration of FIG. 1), which is arranged in or upstream of the ventilation line, against moisture, UV radiation and dirt from outside. The membrane 27 can be arranged, for example, on an inner side of the housing wall 7, so that it closes or covers, respectively, the ventilation line 21 in an air-permeable manner (not shown in FIG. 1).

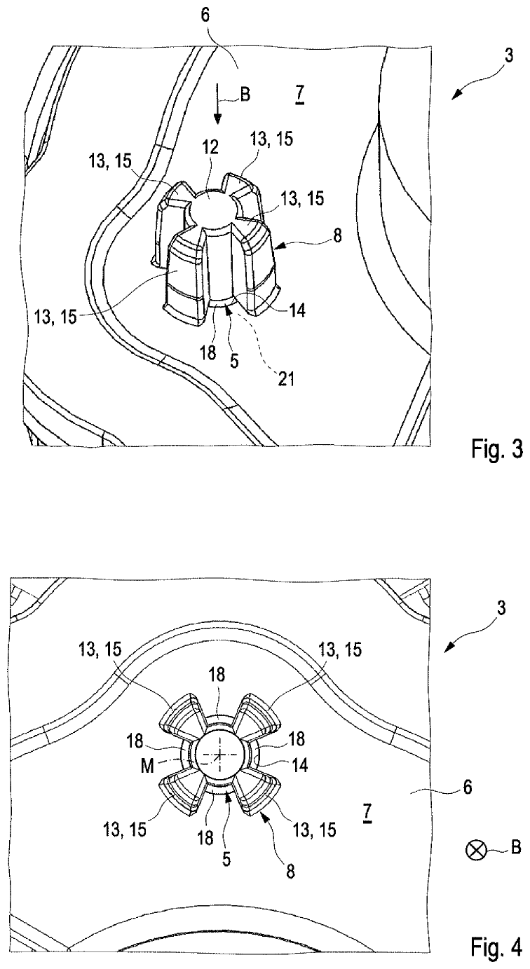

FIG. 3 shows the actuator housing 3 in a detail illustration in the area of the positioning dome 8, FIG. 4 in a top view from outside onto the actuator housing 3 in the area of the positioning dome 8. It can be gathered from FIG. 3 that the positioning dome 8 has a main body 12, which merges radially on the outside into at least four fastening elements 13, by means of which the positioning dome is connected to the housing wall 7 or is formed thereon, respectively. The main body 12 thus merges into the housing wall 7 by means of the fastening elements 13.

As shown in FIG. 4 in the top view onto the housing wall 7, the main body 12 preferably has a round geometry, preferably the geometry of a circle. In this top view, each of the fastening elements 13 in each case has the geometry of a segment of a circle projecting away from the main body 12 radially on the outside. The fastening elements 13 can also be formed in the manner of fastening webs 15, which, in the top view, extend radially outward away from the cylindrical main body 12.

According to FIG. 4, the positioning dome 8 partially covers or closes, respectively, the ventilation opening in the top view along a viewing direction B perpendicular to the housing wall 7, namely in such a way that four venting slots 18 are formed and are visible in the top view along the viewing direction B. A venting slot 18 is thus in each case formed along the circumferential direction of the circular main body 12 between two adjacent fastening elements 13. The positioning dome 8 is thus arranged on the ventilation opening 5 in such a way that the ventilation opening 5 is formed by four venting slots 18. In alternatives of the example, a different number of venting slots 18 can also be formed. In the top view along the viewing direction B relative to a center M of the ventilation opening, the four fastening elements 13 have a 90° rotational symmetry.

When looking at the illustration of FIG. 2 again, it can be seen that a respective outer circumferential side 16 of the fastening elements 13 abuts on an inner circumferential side 17 of the housing flange 10, which delimits the recess 11 when the actuator 2 is mounted on the exhaust gas turbocharger. According to FIGS. 3 and 4, the ventilation opening 5 is thereby delimited by an opening edge 14, which has a circular shape in the example scenario. The main body 12 of the positioning dome 8 is arranged completely inside the opening edge 14. The four fastening elements 13 project radially outward beyond the opening edge 14 and are connected to the housing wall 7 of the actuator housing 3 in this way.

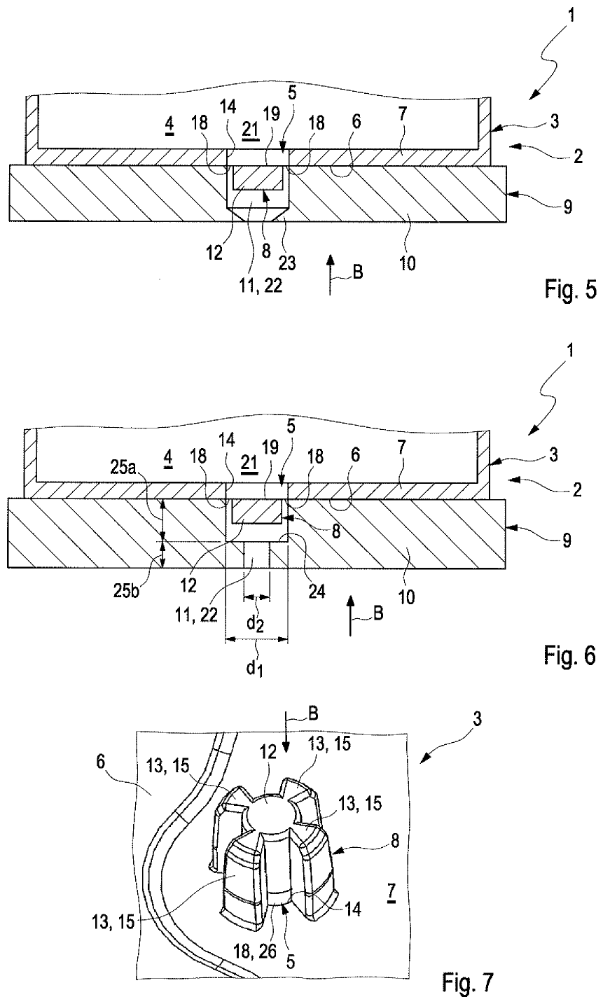

FIG. 5 shows the assembly 1 of FIGS. 1 to 4 in a schematic, highly simplified longitudinal section. The recess 11 provided on the housing flange 10 can thus be formed as passage opening 22. An inner side 19 of the main body 12 facing the housing wall 7 is thereby arranged flush with an outer side 6 of the housing wall 7. In the example of FIG. 5, the venting slots 18 are covered in an opaque manner in top view along the viewing direction B perpendicular to the housing wall 7. For this purpose, a ring-shaped projection 23, which projects radially inward into the passage opening 22, is formed on the housing flange 10. The projection 23 can be formed integrally on the housing flange. In a simplified alternative of the example of FIG. 5, in which the projection 23 is forgone (not shown), the four venting slots 18 are visible in the top view along the viewing direction B perpendicular to the housing wall 7.

FIG. 6 shows an alternative of FIG. 5. To cover the four venting slots 18 in an opaque manner, the passage opening 22, which is present in the housing flange 10, has a radial step 24. The radial step 24 divides the passage opening 23 into a first axial section 25a, which faces the actuator housing 3 and comprises a first opening diameter d₁, and into a second axial section 25b, which faces away from the actuator housing and comprises a second opening diameter d₂. The second opening diameter d₂ is smaller than the first opening diameter d₁ and is selected in such a way that the venting slots 18 are covered in an opaque manner in the viewing direction B. The projection 23 according to the alternative according to FIG. 5 can thus be forgone.

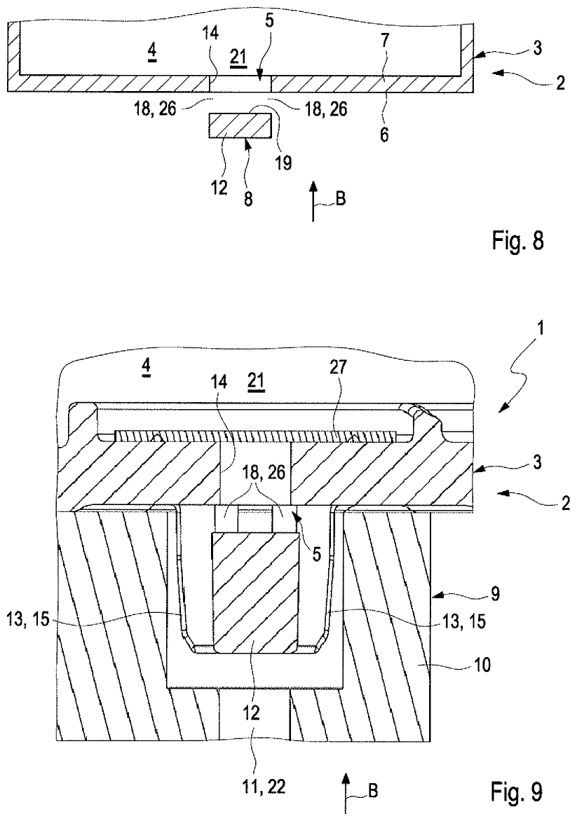

FIGS. 7 to 9 show an alternative of the example of FIGS. 1 to 6. Analogously to FIG. 3, FIG. 7 shows a perspective illustration onto the housing wall 7. Analogously to FIG. 5, FIG. 8 shows a roughly schematic sectional illustration. FIG. 9 is a more detailed illustration of FIG. 8. In the example of FIGS. 7 and 8, the inner side 19 of the main body 12 facing the housing wall 7 is arranged at a distance from the outer side 6 of the housing wall 7 along the viewing direction B perpendicular to the housing wall 7, namely in such a way that the venting slots 18 are formed by means of a space 26, which is present between the housing wall 7 and the main body 12 (in the perspective illustration of FIG. 7, only a single one of such venting slots 18 can be seen). The main body 12 of the positioning dome 8 closes the ventilation opening 5 in an opaque manner along the viewing direction B perpendicular to the housing wall 7.

The ventilation line 21, which has already been mentioned in connection with FIG. 1, and the membrane 27, which closes the ventilation line 21, can be gathered from FIG. 9.

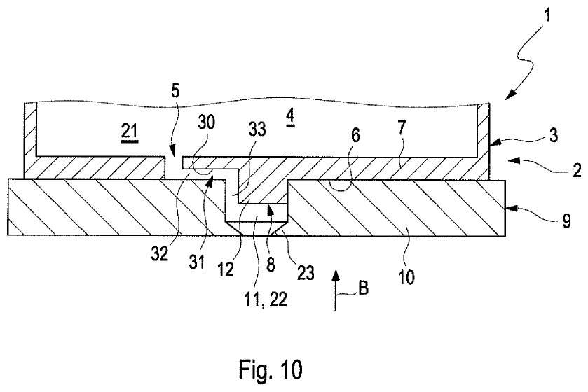

FIG. 10 illustrates an alternative of the example of FIG. 5. In the example of FIG. 10, the ventilation opening 5 is arranged on the actuator housing 3 laterally offset to the positioning dome 8. To ensure the required fluidic connection between the ventilation opening 5 and the recess 11 provided on the housing flange 10, a depression 30 is formed on the outer side 6 of the actuator housing 3 between the ventilation opening 5 and the positioning dome 8. When the actuator 2 is mounted on the housing 9, this depression 30 forms a ventilation duct 31, which fluidically connects the ventilation opening 5 and thus also the ventilation line 21 to the recess 11 provided on the housing flange 10.

As can be seen in FIG. 10, the positioning dome 8 delimits the ventilation duct 31 in some sections. Starting at the ventilation opening 5, the ventilation duct 31 can in particular have a first duct section 32, which is delimited by the housing flange 10 and the housing wall 7, and which, towards the positioning dome 8, merges into a second duct section 33, which is delimited by the housing flange 10 and by the positioning dome 8. Advantageously, the first duct section 32 is arranged at an angle, preferably, as shown in FIG. 10, orthogonally to the second duct section 33.

1.-28. (canceled)

29. An assembly, comprising:
an actuator mountable on at least one of an exhaust gas turbocharger and an air management system, the actuator including an actuator housing delimiting an actuator housing interior space and a ventilation line disposed within the actuator housing, the ventilation line guided from the actuator housing interior space to an outside and opening out in a ventilation opening arranged on an outer side of a housing wall of the actuator housing;
a housing including a housing flange;
the ventilation line closed via an air-permeable and liquid-impermeable membrane;
the actuator further including a positioning dome arranged on the ventilation opening and projecting outward from the actuator housing, the positioning dome disposed integrally on the actuator housing; and
wherein, when the actuator is mounted on the housing, the positioning dome engages a recess disposed on the housing flange facilitating positioning the actuator housing relative to the housing flange.

30. The assembly according to claim 29, wherein the positioning dome at least one of (i) at least partially closes and (ii) at least partially covers the ventilation opening, and wherein the positioning dome is arranged on the ventilation opening such that the ventilation opening is defined by at least two venting slots.

31. The assembly according to claim 30, wherein the positioning dome partially covers the ventilation opening in a viewing direction extending perpendicular to the housing wall such that the at least two venting slots are visible in the viewing direction.

32. The assembly according to claim 31, wherein:
the positioning dome has a main body that, in a top view onto the housing wall, merges radially outward into at least two fastening elements via which the positioning dome is connected to the housing wall;
the main body is arranged completely inside an opening edge of the ventilation opening; and
the at least two fastening elements project radially outward beyond the opening edge of the ventilation opening and are connected to the housing wall such that the at least two venting slots are formed by areas of the ventilation opening that are not covered by the positioning dome in the top view onto the housing wall.

33. The assembly according to claim 32, wherein an inner side of the main body facing the housing wall is arranged flush with the outer side of the housing wall.

34. The assembly according to claim 30, wherein:
the positioning dome has a main body that, in a top view onto the housing wall, merges radially outward into at least two fastening elements via which the positioning dome is connected to the housing wall; and
an inner side of the main body facing the housing wall is arranged at a distance from the outer side of the housing wall such that the at least two venting slots are defined by a space formed between the outer side of the housing wall and the inner side of the main body.

35. The assembly according to claim 34, wherein the main body closes the ventilation opening in an opaque manner along a viewing direction extending perpendicular to the housing wall.

36. The assembly according to claim 29, wherein the positioning dome has a main body that, in a top view onto the housing wall, merges radially outward into at least two fastening elements via which the positioning dome is connected to the housing wall.

37. The assembly according to claim 36, wherein, in the top view onto the housing wall, the main body has a circular geometry, and the at least two fastening elements each have a geometry of a segment of a circle projecting radially outward from the main body.

38. The assembly according to claim 36, wherein the at least two fastening elements are each structured as a fastening web and, in the top view onto the housing wall, extend radially outward from the main body.

39. The assembly according to claim 36, wherein, when the actuator is mounted on the housing, a respective outer circumferential side of the at least two fastening elements abuts on an inner circumferential side of the housing flange delimiting the recess.

40. The assembly according to claim 36, wherein the at least two fastening elements includes four fastening elements projecting from the main body and partially covering the ventilation opening such that the ventilation opening is defined by four venting slots.

41. The assembly according to claim 40, wherein the four fastening elements have a 90° rotational symmetry with respect to a center of the ventilation opening.

42. The assembly according to claim 36, wherein the positioning dome projects outwardly away from the housing wall and is arranged concentrically to the ventilation opening.

43. The assembly according to claim 29, wherein the positioning dome is disposed integrally on the housing wall of the actuator housing.

44. The assembly according to claim 29, wherein the recess disposed on the housing flange is structured as a passage opening.

45. The assembly according to claim 44, wherein:
the positioning dome is arranged on the ventilation opening such that the ventilation opening is defined by at least two venting slots; and
the passage opening is configured such that, when the actuator is mounted on the housing, the at least two venting slots are one of covered in an opaque manner and visible, in a top view along a viewing direction extending perpendicular to the housing wall.

46. The assembly according to claim 45, wherein:
the at least two venting slots are visible in the top view along the viewing direction; and
the housing flange includes at least one projection projecting radially inward into the passage opening such that the at least two venting slots are covered in an opaque manner via the at least one projection in the viewing direction.

47. The assembly according to claim 45, wherein:
the at least two venting slots are visible in the top view along the viewing direction;
the passage opening includes a radial step dividing the passage opening into a first axial section facing the actuator housing and having a first opening diameter, and into a second axial section facing away from the actuator housing and having a second opening diameter; and
the second opening diameter is smaller than the first opening diameter and is defined such that the at least two venting slots are covered in an opaque manner in the viewing direction.

48. The assembly according to claim 29, wherein the actuator further includes at least one further positioning dome arranged on the actuator housing, the further positioning dome engaging a further recess disposed on the housing when the actuator is mounted on the housing.

49. An exhaust gas turbocharger, comprising an assembly according to claim 29.

50. An air management system, comprising an assembly according to claim 29.
